(19) United States
(12) Patent Application Publication
(10) Pub. No.: US 2007/0248414 A1
(43) Pub. Date: Oct. 25, 2007

(54) Method and apparatus for making a pool

(76) Inventor: Ralph Fratianni, Pembroke Pines, FL (US)

Correspondence Address: MAYBACK & HOFFMAN, P.A., 5722 S. FLAMINGO ROAD #232, FORT LAUDERDALE, FL, 33330, US

(21) Appl. No.: 11/788,731

(22) Filed: Apr. 20, 2007

Related U.S. Application Data
(60) Provisional application No. 60/793,775, filed on Apr. 21, 2006.

(51) Int. Cl. B65G 5/00

(52) U.S. Cl. 405/53

(57) ABSTRACT

An apparatus for forming a pool includes a panel of waterproof material supportable by a surface of a concaved area of sand and at least one pouch coupled to an outer edge of the material, the at least one pouch capable of holding a weighting substance and preventing an entire outer edge of the material from being relocated by wind.

### CROSS-REFERENCE TO RELATED APPLICATIONS

This application is based on, and claims priority from prior co-pending U.S. Provisional Patent Application No. 60/793,775, filed on Apr. 21, 2006, the teachings thereof being hereby incorporated by reference in its entirety.

### FIELD OF THE INVENTION

The present invention relates generally to forming a pool in the sand, and more particularly relates to a portable beach pool that can be placed within a hole dug in the sand and, thereafter, filled with water.

### BACKGROUND OF THE INVENTION

Those that live in coastal regions or that are able to travel to a coastline often take advantage of nature's resources, in particular, the beach and the ocean. However, the beach, due to incoming and outgoing waves and often accompanied by undercurrents, can be unsafe for small children. As there are typically no alternatives at the beach for enjoying water other than getting into the moving ocean water, parents and/or caregivers must constantly be on guard and/or accompany children into the water.

One activity that children enjoy is using buckets and shovels to dig holes in the sand. They also often use the bucket to transport water from the ocean to their holes. However, water quickly drains into the sand and provides very little reward for the work invested in carrying the water.

Swimming pools exist that hold water and allow a person to enter the pool and enjoy the water within. Pools avoid most of the dangers of the moving ocean. One such pool is sold at many stores and is generally a molded plastic form of sufficient stiffness to avoid deformation under the force of the water placed within and the weight of one or two users. Although these pools can generally be carried by a single person, they are too big to fit inside a typical automobile and are not portable to where they can easily be carried to the beach. In addition, heavy winds, which frequently occur on beaches, can easily pick up these plastic pools when unfilled and hurtle the hard plastic pool in the direction of other beachgoers, potentially causing injury. Furthermore, all known small pools take up considerable space on the beach and would take a massive effort on the part of the user to fill up.

Therefore a need exists to overcome the problems with the prior art as discussed above.

### SUMMARY OF THE INVENTION

Briefly, in accordance with the present invention, disclosed is an apparatus for forming a pool, the apparatus including a panel of waterproof material supportable by a surface of a concaved area of sand, and at least one pouch coupled to an outer edge of the panel, the pouch capable of holding a weighting substance/mass and preventing an entire outer edge of the panel from being relocated by wind.

In accordance with another feature, an embodiment of the present invention includes an opening on at least one of the pouches, the opening being sealable and capable of preventing a material inside the pouch from exiting the pouch.

In accordance with a further feature of the present invention, an interior of the pouch is waterproof.

In accordance with a further feature of the present invention, the pouch is an elongated continuous pouch that substantially follows an outer edge of the material

In accordance with another feature, there is provided an opening located substantially near a center point of the material, the opening being waterproof in a first state and allowing water to pass there through in a second state.

In accordance with yet another feature, the material has a tensile strength sufficient to support a weight of an adult human (for example, at least 150 lbs) without tearing or permanently substantially deforming.

With objects of the invention in view, there is also provided a waterproof section of material that, when supported by a concaved area of sand, is capable of supporting a human and an elongated curved spring that is coupled to an outer edge of the material, wherein the material is dimensioned so as to form a concaved surface when supported by the curved spring.

With objects of the invention in view, there is also provided a method for creating a pool of water on a beach, where the method includes the steps of removing an amount of sand from an area on a beach so as to create a concaved area in the sand, lining the concaved area with a liner, the liner including: a section of material that, when supported by a surface of the concaved area in the sand, is capable of holding water; and at least one pouch coupled to an outer edge of the material, the at least one pouch capable of holding a weighting substance and preventing the material from being relocated by a gust of wind, and placing water on the liner so as to partially fill the concaved area.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a cross-sectional/vertically cross-sectional view of a pool in accordance with the present invention;

FIG. 2 is a cross-sectional/vertically cross-sectional view of the pool of FIG. 1 being at least partially filled with water in accordance with the present invention;

FIG. 3 is a top/plan view of an inventive portable pool in accordance with the present invention;

FIG. 4 is a top/plan view of the portable pool of FIG. 3 with weight holding pouches distributed along an edge in accordance with the present invention;

FIG. 5 is a perspective view of an alternative embodiment of a pool in accordance with the present invention having spring material along its edge, the spring material being held in a plane in free space;

FIG. 6 is a perspective view of an inventive pool having weight holding pouches in accordance with an embodiment of the present invention; and

FIG. 7 is a process flow diagram of a method for using an inventive pool in accordance with an exemplary embodiment of the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The present invention, according to an embodiment, overcomes problems with the prior art by providing a portable pool that can be folded into a package small enough to fit inside a backpack, purse, or even smaller carrier, and then unfolded and placed upon and supported by the concaved surface of a hole dug in the sand. Once water is added to the pool, children, adults, or even animals can play in water and still remain in the vicinity of the parents and/or caregivers all without the attendant dangers of a typical beach.

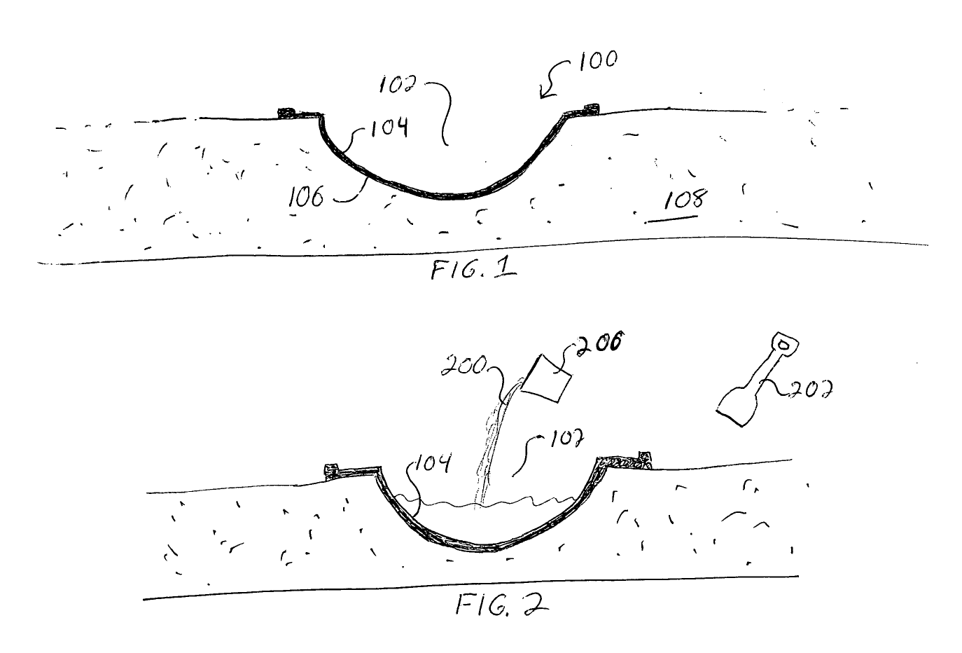

Described now are exemplary embodiments of the present invention. With reference to the drawings, FIG. 1 shows a side edge-view of a portable beach pool 100 in accordance with an embodiment of the present invention. The portable beach pool 100 is constructed at least partially of a waterproof material rendering it able to hold water when placed in a cavity 102 made in a volume of sand 108. More specifically, the material 104 lines a concaved surface 106 of the cavity 102 made in the sand 108.

As shown in FIG. 2, once the cavity 102 is lined with the material 104, water 200 can be poured on top of the material 104. The beach pool 100, which is constructed of waterproof material 104, holds the water 200, thereby forming a swimming or wading pool. Advantageously, the pool 100 allows small children to undertake water recreational activities without undertaking the above-mentioned risks associated with the ocean. Advantageously, one can selectively choose where the cavity 100 is formed, so that children or others are able to play in the water 200 close to where the parents or guardians are stationed but away from the actual ocean. In this way, the beach pool 100 also alleviates the stress normally placed upon the guardians of children who are playing at the beach.

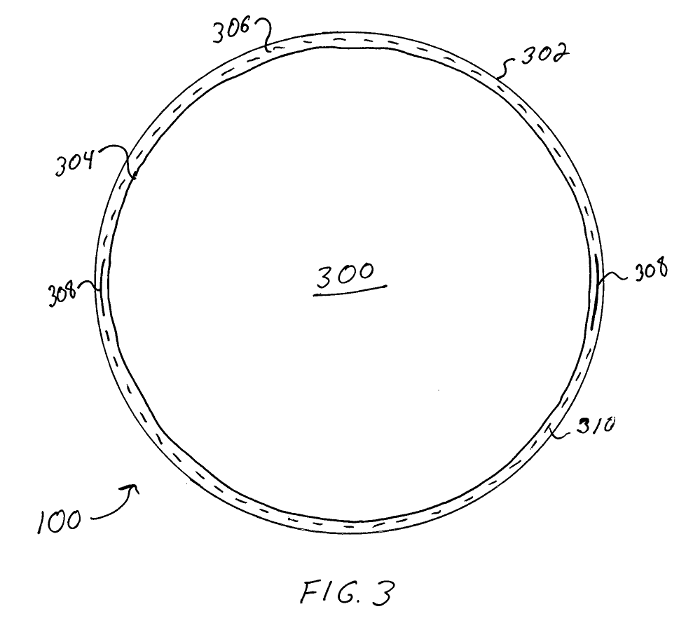

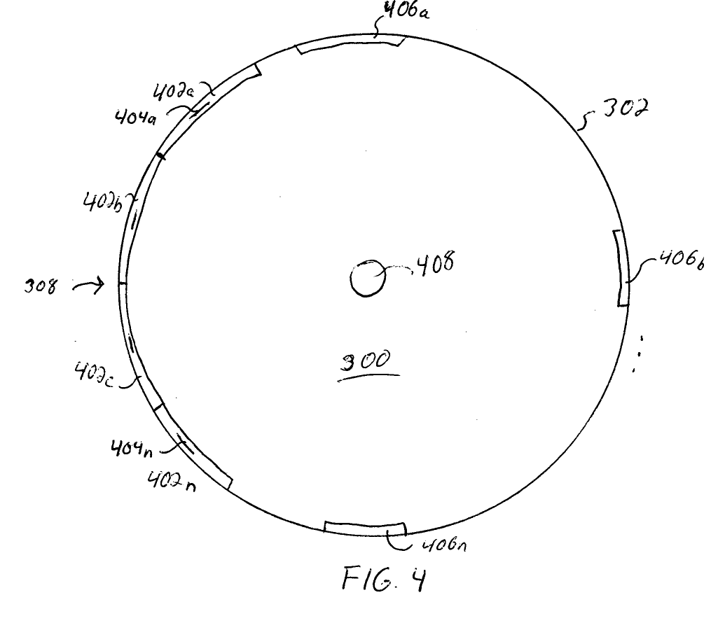

FIG. 3 shows a top view of an exemplary embodiment of the present invention. As can be seen, the pool 100 is generally circular in shape and is defined by an outer edge 302. The invention, however, is not limited to any particular shape and can be offered in alternative shapes, such as square, diamond, triangular, combinations thereof, and many others. The pool 100 shown in FIG. 3 includes a section of material 300, which, in one exemplary embodiment, is a panel of pliable plastic or otherwise waterproof material. The section of material 300 may be made, for example, of a polyester canvas with polyurethane coating, plasticized polyvinyl chloride (PVC) and, or low-density polyethylene (LDPE). The panel of material 300, in one exemplary embodiment, is constructed of polyester canvas with dimensions of about five feet (5′) in diameter. A polyurethane coating can advantageously be applied to the panel of polyester canvas material 300 to enhance water resistance. In one embodiment, the material has a burst strength of up to 700 lbs/square inch. The burst strength is selected so as to support the weight of one or more users without tearing or deforming.

The material 300 is preferably durable, waterproof, puncture resistant, acid-resistant, alkali-resistant and UV resistant to inhibit the harmful affects of UV rays. The beach pool 100 may include seamed sidewalls in various formats, such as diagonal extensions from a square center, to assist users in determining, accommodating and maintaining its placement. In one embodiment, the material is reflective. When the material is reflective, the sun's rays from the material back into the water contained within the pool 100 to heat the water. This can be advantageous on cold days or in locations, such as Northern California, where the ocean water is usually cold.

In one embodiment, the presently inventive pool 100 has an inner seam 304. One way of manufacturing the pool 100 is by folding the outer edge 302 in toward the center of the pool 100 and the sewing the seam 304 onto the folded material, thereby creating a sleeve 306 of material 300. The sleeve can be useful for multiple purposes. For example, the sleeve 306 can be a weighting pouch for storing therein a weighting material/mass, such as lead. Other weighting materials can include sand and water, which can be introduced into the sleeve 306 through one or more openings 308. Using sand or water as a weighting material is advantageous because the user does not have to store or carry the heavy material to and from the beach, but can, instead, temporarily use the natural materials already present at the beach. In some embodiments, the openings 308 are sealable, for instance, by a zipper or with Velcro®. If water is to be the preferred weighting material, the opening 308 will be waterproof when sealed, such as by a mechanism, found on household food storage bags, a corking mechanism, or others.

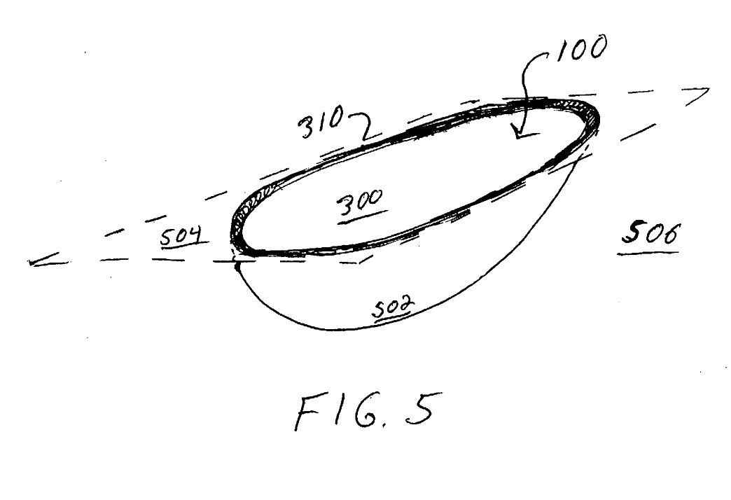

In some exemplary embodiments, the sleeve 308 is not continuous. In these embodiments, some of which are shown in FIG. 4, the sleeve 308 may be divided into sections 402a-n, each of which having their own opening 404a-n. With the separate sections 402a-n, a user can chose to fill as many sections as are necessary based on the weather conditions of a particular day. In other exemplary embodiments, one or more small sleeves 406a-n are spaced away from the other sleeves. In this embodiment, the sleeves can be strategically spaced along the edge 302 so as to prevent the edge from flipping over due to wind conditions. Preferably, the weights will be positioned so that at least two opposing sides, such as 406a and 406n, of the material are prevented from being relocated by wind. The term “opposing sides,” as used herein, is not meant to indicate a true opposite side, but instead is meant to indicate two positions along the edge that are sufficiently spaced apart and that will prevent two edge positions from being relocated.

In another exemplary embodiment, the sleeve 308 includes a length of curved spring steel or hardened plastic 310, shown as a dotted line in FIG. 3. The curved spring 310 can be similar to the light-weight springs that are used with fold-up dashboard shades that are commonly known and used by the public. The use of the spring is advantageous, as it easily and quickly collapses into a “figure 8” configuration, thereby immediately reducing the size of the pool 100 by 50% for storage. Depending on the spring used, the pool can be reduced in size again by folding the spring into another “figure 8.” Thereby, the size of the pool will be reduced by an additional 50%. When in its full-size configuration, the spring 310 is rigid and holds its shape, thereby preventing any portion of the outer edge 302 from folding over into the main pool area 300.

It should be noted that the spring 310 does not have to be in the sleeve 306, but can be attached to the material 302 anywhere and by any method. In addition, the sleeve 306 is not necessary when a spring 310 is present, as weight is likely not needed.

As is shown in FIG. 5, in an exemplary embodiment where the spring 310 is present in the inventive pool 100, the material 300 is dimensioned so that, as can be seen by the perspective edge view of FIG. 5, a center portion 502 of the material 300 is capable of automatically hanging below a plane 504 formed by the elongated curved spring 310 when substantially an entire length of the elongated curved spring is held in a horizontal plane in free space 506.

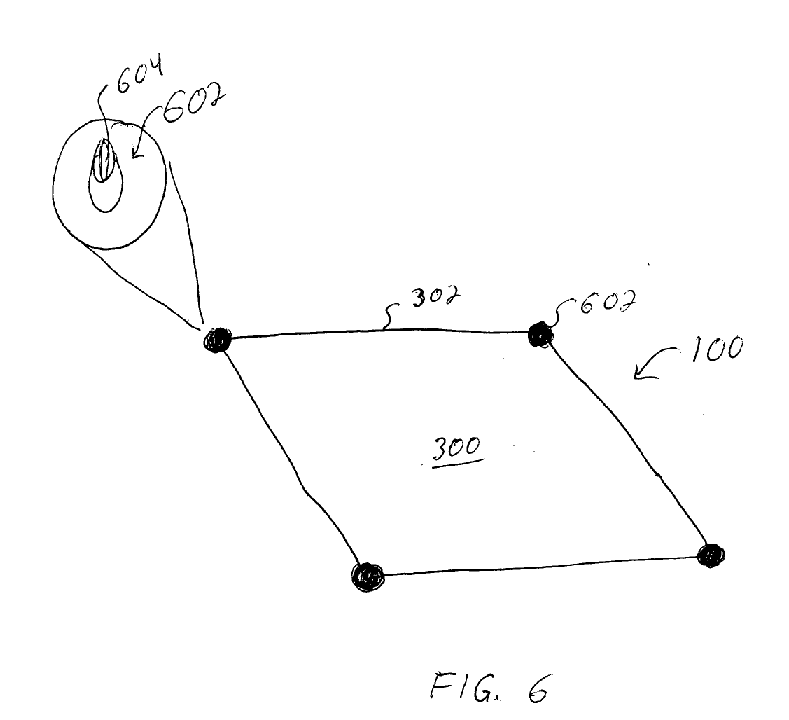

In another exemplary embodiment, shown in FIG. 6, the pool 100 includes one or more pouches, or hollow receptacles 602 that are coupled to the outer edge 302 of the material 300. The pouches 602 can be temporarily attached to the outer edge 302 of the pool 100, can be integral with the outer edge 302, can be near the edge 302, or in any other configuration. The pouches 602 are capable of holding weights for the purpose of preventing the pool 100 from flying away in the wind or the edges 302 of the pool 100 being blown into the water, thereby allowing the water 200 to exit the cavity 102 of the sand, as shown in FIG. 1. In one embodiment of the present invention, the pouch 602 is provided with weights. In others, where the weight of the pool 100 is reduced until the pool 100 is ready for use, the pouches 602 are capable of receiving and holding a weighting substance, such as lead, sand, water, and others that are capable of preventing the material from being relocated by a gust of wind. To facilitate adding the weighting material to the pouches 602, the pouches 602, in one embodiment, are provided with an opening 604. The opening 604 can be sealable and capable of preventing the material inside the pouch 602 from easily falling out of or exiting the pouch 602. In an embodiment where water 200 is a potential weighting material, the interior of the pouch 304 is waterproof. Of course, in any embodiment of the present invention, the pouches can be emptied or even removed after the pool is at least partially filled with water.

Alternatively, stakes or attached weight pieces of various applicable materials may be used to secure the pool 100 to the beach 108. In one embodiment, the receptacles 602 are attached to the material 300 by synthetic stitch and each comprise a hollow cylinder of approximately four-inch diameter by four-inch height (4″×4″).

Referring now back to FIG. 2, in one embodiment, the presently inventive pool 100 is placed by using a shovel 202 to dig the hole 102 to place the panel of material 104. A bucket 206 is then used for collecting the water 200 and pouring it into the cavity 102 that is lined with the material 104.

The outer perimeter of the beach pool 100 may be hemmed to improve durability. An upper surface of the panel 104 can be made of a textured surface to improve traction and prevent slippage. The lower surface—the surface that makes contact with the sand 108—can be made of a frictionless, or substantially smooth material, so that the pool 100 can be easily slid out from under the water 200. As shown in FIG. 4, the pool 100 can also be provided with an opening 408, or drain, located substantially near a center point of the material 300. The opening can have snaps, a zipper, or other means of sealing so that when it is in a first closed position, it is sealed in a waterproof manner. The opening, when in a second, open position, allows water to pass through the opening so as to allow the pool to drain.

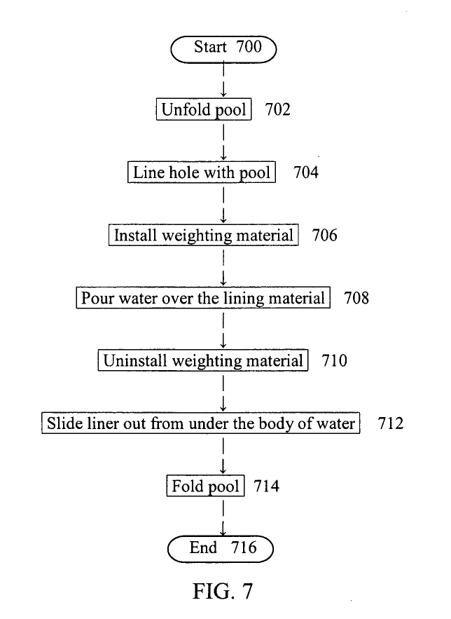

FIG. 7 shows a process flow of the steps for making a pool with the present invention. The flow begins at step 700 and moves directly to step 702 where a user digs a hole in the sand. Once the hole is of desired size to hold water, in step 703, the pool 100 is unfolded. In step 704, the hole is lined with the inventive pool 100. In step 706, the pouches 602 or sleeves 402 are filled with weighting material. Next, in step 708, water is poured over the lining material to sufficient depth to create a pool of water that can be enjoyed by a user. In step 710, after use of the pool is no longer desired, the pouches 602 or sleeves 402 are emptied. Then, in step 712, the liner is slid out from under the body of water occupying the pool. In step 714, the pool 100 is folded into a small size and place back into its carrying package. The flow ends at step 716. In an exemplary embodiment where the weighting material is permanently associated with the pool, steps 704 and 710 are eliminated.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

The terms “a” or “an”, as used herein, are defined as one, or more than one. The term “plurality”, as used herein, is defined as two, or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

What is claimed is:

1. An apparatus for forming a pool, the apparatus comprising:
a panel of waterproof material supportable by a surface of a concaved area of sand; and
at least one pouch coupled to an outer edge of the panel, the at least one pouch capable of holding a weighting substance and preventing an entire outer edge of the panel from being relocated by wind.

2. The apparatus according to claim 1, wherein:
the at least one pouch defines a selectively sealable opening capable of preventing a weighting material inside the at least one pouch from exiting the at least one pouch.

3. The apparatus according to claim 1, wherein:
an interior of the at least one pouch is waterproof.

4. The apparatus according to claim 1, further comprising:
a weighting substance located in the at least one pouch.

5. The apparatus according to claim 1, wherein:
the at least one pouch is an elongated continuous pouch that substantially follows an outer edge of the panel.

6. The apparatus according to claim 1, wherein:
a shape of the panel is substantially one of square, round, octagonal, diamond, and triangular.

7. The apparatus according to claim 1, wherein:
the panel has a convex shape.

8. The apparatus according to claim 1, wherein:
the panel has a first surface and a second surface, the first surface being slip-free textured.

9. The apparatus according to claim 1, wherein:
the second surface is substantially smooth.

10. The apparatus according to claim 1, wherein:
the panel defines an opening located substantially near a center point thereof, the opening operable to be waterproof in a first position and allow water to pass through the opening in a second position.

11. The apparatus according to claim 1, wherein:
the material has a tensile strength sufficient to support a weight of at least one adult human without tearing or permanently substantially deforming.

12. An apparatus for forming a pool, the apparatus comprising:
a waterproof section of material that, when supported by a concaved area of sand, is capable of supporting an adult human; the material having an outer edge; and
an elongated curved spring that is coupled to the outer edge, the section of material being dimensioned to form a concaved surface when supported by the curved spring.

13. The apparatus according to claim 12, wherein the section of material is substantially circular-shaped.

14. The apparatus according to claim 12, further comprising:
an elongated sleeve substantially following the outer edge of the material.

15. The apparatus according to claim 14, wherein:
the elongated sleeve is capable of securely holding a weighting material.

16. The apparatus according to claim 15, wherein:
the spring material is located within the sleeve.

17. The apparatus according to claim 12, wherein the material is dimensioned to have a center portion of the material automatically hang below a plane formed by the elongated curved spring and the sleeve when substantially an entire length of the elongated curved spring is held in a substantially horizontal plane in free space.

18. A method for creating a pool of water on a beach, the method comprising:
removing an amount of sand from an area on a beach to create a concaved area in the sand;
lining the concaved area with a liner, the liner including:
a section of material that, when supported by at least a portion of the concaved area in the sand, is capable of holding water; and
at least one pouch coupled to an outer edge of the material, the at least one pouch capable of holding a weighting substance and preventing the material from being relocated by wind when holding the weighting substance; and
placing water on the liner to at least partially fill the concaved area.

19. The method according to claim 18, further comprising:
providing the at least one pouch with a selectively sealable opening for receiving a weighting substance; and
placing a weighting substance through the opening and into the at least one pouch, the opening being preventing the weighting substance inside the at least one pouch from exiting the at least one pouch.

20. The method according to claim 18, further comprising:
attaching a spring to an edge of the liner;
twisting the spring to selectively cause the liner to reduce to a compressed state and expand from the compressed state.
